(19) United States
(12) Patent Application Publication
(10) Pub. No.: US 2017/0352199 A1
(43) Pub. Date: Dec. 7, 2017

(54) GROUND ENGAGING TOOL MANAGEMENT

(71) Applicant: ESCO Corporation, Portland, OR (US)

(72) Inventors: Taylor M. Finley, Lake Oswego, OR (US); Christopher M. Carpenter, Tualatin, OR (US); Eric E. Wilkinson, Happy Valley, OR (US)

(21) Appl. No.: 15/610,563

(22) Filed: May 31, 2017

Related U.S. Application Data
(60) Provisional application No. 62/344,312, filed on Jun. 1, 2016.

(51) Int. Cl. G07C 5/00; G06T 7/13; E02F 9/26; G07C 5/08; E02F 3/30

(52) U.S. Cl. CPC G07C 5/006; E02F 9/268; E02F 9/267; G07C 5/0825; G07C 5/008; G06T 7/13; E02F 3/308; G07C 2205/02

(57) ABSTRACT

A process, system and device for monitoring a ground engaging tool secured to earth working equipment that includes capturing an image of the ground engaging tool secured to the earth working equipment and subjected to wearing with a mobile device, determining a dimension of the ground engaging tool subject to wear, operating at least one processor and memory storing computer-executable instructions to calculate at least one result including the extent of wear experienced by the ground engaging tool and/or an estimate of when the ground engaging tool will reach a fully worn condition, and/or schedule when to replace the ground engaging tool.

### RELATED APPLICATIONS

This application claims priority to U.S. Provisional Patent Application No. 62/344,312, filed Jun. 1, 2016, entitled “Wear Part Management Utilizing a Mobile Device,” which is incorporated by reference in its entirety herein and made a part hereof.

### FIELD OF THE INVENTION

The present disclosure relates to systems, processes and devices for monitoring ground engaging tools secured to earth working equipment to assist earth working operations by, for example, determining wear, estimating fully worn conditions, scheduling replacement of ground engaging tools, sending alerts, and the like.

### FIELD OF THE INVENTION

In mining and construction, ground engaging tools (e.g., teeth and shrouds) are commonly provided on earth working equipment (e.g., buckets) to protect the underlying equipment from undue wear and, in some cases, also perform other functions such as breaking up the ground ahead of the digging edge. For example, buckets for excavating machines (e.g., dragline machines, cable shovels, face shovels, hydraulic excavators, wheel loaders and the like) are typically provided with ground engaging tools (such as excavating teeth and shrouds) secured along the lip or digging edge. A tooth includes a point (or tip) secured to a base secured to the lip or formed as a projection on lip. The point initiates contact with the ground and breaks up the ground ahead of the digging edge of the bucket. Ground engaging tools are also used on other earth working equipment and can include tools such as, for example, teeth on a dredge cutter head and picks on a rotating drum.

During use, ground engaging tools can encounter heavy loading and highly abrasive conditions. These conditions cause the tools to wear and eventually become fully worn, i.e., where they need to be replaced. Tools that are not timely replaced, can be lost, cause a decrease in production, and/or lead to unnecessary wear of other components (e.g., the base).

### SUMMARY OF THE INVENTION

The following presents a simplified summary of the present disclosure in order to provide a basic understanding of some aspects of the disclosure. This summary is not an extensive overview of the disclosure. The following summary merely presents some concepts of the disclosure in a simplified form as a prelude to the more detailed description provided below.

Certain embodiments of the disclosure involve a streamlined and/or efficient process for capturing use and determining the wear of a ground engaging tool secured to earth working equipment. Disclosed herein are apparatuses, methods, and computer-readable media for monitoring and/or predicting wear life of ground engaging tools to lessen unplanned downtime and/or improve supply chain accuracy.

In one embodiment, a process for monitoring a ground engaging tool secured to earth working equipment includes capturing an image of the ground engaging tool with a mobile device and showing the captured image on the display. The process determines a dimension of the ground engaging tool, and operates at least one processor and memory storing computer-executable instructions to calculate at least one result including the extent of wearing experienced by the ground engaging tool and/or an estimate of when the ground engaging tool will reach a fully worn condition.

In another embodiment, a process of monitoring a ground engaging tool secured to earth working equipment includes capturing, via a mobile device, an image comprising the ground engaging tool secured to the earth working equipment, and displaying, via a user interface on the mobile device, the captured image of the ground engaging tool, and edge markers overlying the captured image of the ground engaging tool to indicate a dimension of the ground engaging tool. Input can be received via the user interface, to adjust at least one of the edge markers to calculate, by the mobile device, an extent of wear of the ground engaging tool based in part on information from the edge markers.

In another embodiment, a process for scheduling replacement of a ground engaging tool secured to earth moving equipment includes capturing an image of the ground engaging tool with a mobile device and showing the captured image on a display. A dimension can be determined along with capturing the image. At least one processor and memory storing computer-executable instructions can be operated to calculate at least one result including the extent of wearing experienced by the ground engaging tool and/or an estimate of when the ground engaging tool will reach the fully worn condition. The result(s) can be then used to schedule when to replace the ground engaging tool secured to the earth working equipment.

In another embodiment, a process for scheduling replacement of ground engaging tools for earth working equipment includes capturing information on when one or more ground engaging tool is installed, and when the ground engaging tool(s) is removed from the earth working equipment. The earth working equipment and the position of the ground engaging tool on the earth working equipment can be identified, and the steps repeated for successive ground engaging tools installed at the same position on the same machine. The captured information can be used to calculate an average time period the ground engaging tools are in use, which can be used to schedule when the ground engaging tool(s) should be replaced. Alternatively, the process can be used to monitor and capture this information on all the teeth on a machine and in this way schedule complete change out of the monitored ground engaging tools (e.g., all the teeth on a machine) at, e.g., the scheduled downtime for the machine closest (but not after) the fully worn condition is expected for at least one of the ground engaging tools on the machine.

In another embodiment, a process for monitoring a ground engaging tool secured to earth working equipment includes using a mobile device to capture an image of the ground engaging tool and showing on a display of the mobile device the captured image and electronically generated markers. The markers are set to overlie opposite edges of the ground engaging tool in the captured image. The image is calibrated to determine the relationship between a first distance extending between the markers on the display and a second distance extending between the opposite edges of the ground engaging tool. The first and second distances are calculated, and used with data on at least the fully worn condition of the ground engaging tool to determine an extent of wear in the ground engaging tool and/or an estimate of when the fully worn condition of the ground engaging tool will be reached.

In another embodiment, a process for scheduling replacement of a ground engaging tool secured to earth working equipment includes using a mobile device to capture information pertaining to wear of the ground engaging tool at a plurality of different times wherein said times of capturing information are separated from each other by a time of operation for the earth working equipment. The captured information and time lapse between the different times of capturing information is used to calculate the extent of wear at any one of the times of capturing information and estimating when the ground engaging tool will reach a fully worn condition. A time when the ground engaging tool will be replaced is scheduled based on the estimate of when the fully worn condition will be reached.

In another embodiment, a system for monitoring a ground engaging tool secured to earth working equipment includes at least one processor, a communication interface to receive information from a mobile device relating to at least one said ground engaging tool secured to the earth working equipment, and memory storing computer-executable instructions. The received information includes at least one of an image of the ground engaging tool, calibration information relating to the ground engaging tool, and edge markers overlying the image of the ground engaging tool. The processor(s) and computer-executable instructions can calculate an extent of wear of the ground engaging tool and/or an estimate of a fully worn condition of the ground engaging tool based in part on the received information. The extent of wear and/or the estimate of the fully worn condition of the ground engaging tool can be provided to the mobile device via the communication interface. A user interface can show at least one of a portion of the received information, the calculated extent of wear, and/or the estimated fully worn condition of the ground engaging tool.

In another embodiment, use of a mobile device may allow user input (machine, position, etc.), utilize device data (time stamp, location, etc.) and/or capture data (e.g., images, video, etc.) related to one or more ground engaging tools, analyze the tools at one or more work sites, and/or manage the replacement of those tools to maximize operational efficiency and minimize downtime.

In another embodiment, a mobile device for monitoring a ground engaging tool is provided to capture images of one or more ground engaging tools secured to earth working equipment. Each image may optionally include an image of a calibration device to assist in determining the current length of the ground engaging tool. The device may also optionally permit input of data and/or may overlay on the image one or more adjustable edge markers to indicate a dimension of the ground engaging tool. Based on the information from the image, inputted information and/or edge markers, the system can calculate an extent of wear and/or an estimated end-of-life of the ground engaging tool. The system may optionally provide an alert(s) when an end-of-life of a ground engaging tool is at hand or approaching.

In another embodiment, a mobile device for monitoring a ground engaging tool secured to earth working equipment includes at least one processor, a user interface, an imaging device (e.g., a camera), and memory storing computer-executable instructions that, when executed by the processor(s), causes the mobile device to capture an image of the ground engaging tool secured to the earth working equipment and, optionally, a calibration device, determine opposite edges of the ground engaging tool in the image and the distance between the opposite edges, and calculate an extent of wear present in the ground engaging tool and/or an estimate of the remaining useful life using at least the distance between the opposite edges.

In another embodiment, an application stored on a mobile device may be used to capture pertinent data related to ground engaging tool products at a site. A ground engaging tool management server may capture pertinent ground engaging tool data across a job site and manage ground engaging tool replacement.

Further embodiments of the disclosure may be provided in a computer-readable medium having computer-executable instructions that, when executed, cause a computer, user terminal, or other apparatus to at least perform one or more of the processes described herein.

### BRIEF DESCRIPTION OF THE DRAWINGS

All descriptions are exemplary and explanatory only and are not intended to restrict the disclosure, as claimed. The accompanying drawings, which are incorporated in and constitute a part of this specification, illustrate embodiments of the disclosure and, together with the description, serve to explain the principles of the disclosure. In the drawings:

FIG. 1 shows an illustrative operating environment in which various aspects of the disclosure may be implemented.

FIG. 2 shows an overall system of networked devices and servers that may be used to implement the processes and functions of certain aspects of the present disclosure.

FIG. 3 illustrates the ground engaging tool management server and the mobile device and steps performed by these components.

FIG. 4 shows flow chart for initial setup of the mobile device at a mining location.

FIG. 5 shows a flow chart for collection of data from a ground engaging tool.

FIG. 6 is a flow diagram illustrating the steps associated with alerting the user of potential end-of-life conditions.

FIGS. 7-12 show exemplary screen shots of a mobile device during the process of setup and image capture of a ground engaging tool in accordance with certain aspects of the present disclosure.

FIGS. 13a and 13b are illustrations of examples of calibration devices.

### DETAILED DESCRIPTION

In accordance with various embodiments of the disclosure, apparatus, methods, and computer-readable media are disclosed to document use, predict and/or monitor wear life of ground engaging tools to lessen unplanned downtime and/or improve supply chain accuracy. In certain embodiments, a mobile device may capture an image of a ground engaging tool product, measure wear, calculate the remaining life of the product, and/or convey information associated with the remaining life of the product to a customer and/or a ground engaging tool provider, and generate and/or send one or more notifications to the customer and/or the ground engaging tool provider of approaching end-of-life target conditions of a ground engaging tool.

It is noted that various connections between elements are discussed in the following description. It is noted that these connections are general and, unless specified otherwise, may be direct or indirect, wired or wireless, and that the specification is not intended to be limiting in this respect.

The processes disclosed herein may utilize various hardware components (e.g., processors, communication servers, memory devices, sensors, etc.) and related computer algorithms to predict and/or monitor wear life and/or usage of ground engaging tool products.

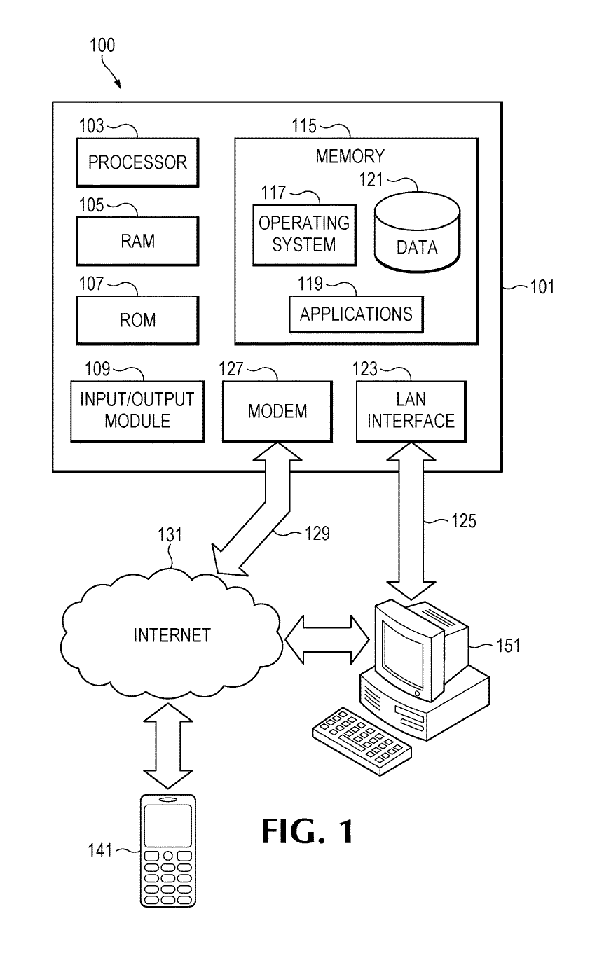

FIG. 1 illustrates a block diagram of a ground engaging tool management server 101 (e.g., a computer server) in a communication system 100 that may be used according to an illustrative embodiment of the disclosure. The server 101 may have a processor 103 for controlling overall operation of the ground engaging tool management server 101 and its associated components, including RAM 105, ROM 107, input/output module 109, and memory 115.

I/O 109 may include a microphone, keypad, touch screen, and/or stylus through which a user of ground engaging tool management server 101 may provide input, and may also include one or more of a speaker for providing audio output and a video display device for providing textual, audiovisual, and/or graphical output. Software may be stored within memory 115 to provide instructions to processor 103 for enabling ground engaging tool management server 101 to perform various functions. For example, memory 115 may store software used by the ground engaging tool management server 101, such as an operating system 117, application programs 119, and an associated database 121. Processor 103 and its associated components may allow the ground engaging tool management server 101 to run a series of computer-readable instructions to analyze image data depicting one or more ground engaging tools. Processor 103 or a similar processor in mobile device 141 may utilize the data to assess the wear of the ground engaging tool and/or predict the end-of-life of the ground engaging tools to lessen unplanned downtime and/or improve supply chain accuracy.

The server 101 may operate in a networked environment supporting connections to one or more remote devices, such as mobile device 141 and computing device 151. The devices 141 and 151 may be personal computers, mobile phones, or tablets that include many or all of the elements described above relative to the server 101. Devices 141 preferably includes a built-in imaging device (e.g., camera and/or camera attachments) for capturing image data associated with one or more ground engaging tools. The image may be a digital photographic image or an electronic representation of the ground engaging tool based on a scan or other way of capturing information related to at least a relevant dimension of the tool Also, mobile device 141 and/or 151 may include data stores for storing image data to be analyzed, by the ground engaging tool management server 101 and/or device 141 or 151.

The network connections depicted in FIG. 1 include a local area network (LAN) 125 and a wide area network (WAN) 129, but may also include other networks. When used in a LAN networking environment, the server 101 is connected to the LAN 125 through a network interface or adapter 123. When used in a WAN networking environment, the server 101 may include a modem 127 or other means for establishing communications over the WAN 129, such as the Internet 131. The Internet 131 may also represent an intranet or a cloud environment. The network connections shown are illustrative and other means of establishing communications links between the computers may be used. Various protocols such as TCP/IP, Ethernet, FTP, and HTTP may be used in establishing the communications links.

In some embodiments, mobile device 141, computing device 151, and/or ground engaging tool management server 101 may execute an application program. As depicted, application program 119 resides in ground engaging tool management server 101, however, the same or similar application program 119 may reside in mobile device 141 and/or computing device 151. The application program 119 may include instructions that, when executed, cause mobile device 141, computing device 151, and/or ground engaging tool management server 101 to document part change or analyze wear of one or more ground engaging tools based on images captured by one or more mobile devices and/or inputted data, calculate expected end-of-life dates and/or times for such ground engaging tools, and/or generate and/or send notifications to one or more other computing devices based on such calculations, where such notifications may direct and/or otherwise cause such devices to present information related to the end-of-life dates and/or times for such ground engaging tools and/or prompt the users of such devices to replace the ground engaging tools and/or take other responsive actions.

Ground engaging tool management server 101 and/or devices 141 or 151 may also be mobile terminals including various other components, such as a battery, speaker, camera, and antennas (not shown).

As illustrated above, aspects of the disclosure may be implemented using special purpose computing systems, environments, and/or configurations. In some instances, the computing systems, environments, and/or configurations that may be used in implementing one or more aspects of the disclosure may include one or more additional and/or alternative personal computers, server computers, hand-held or laptop devices, multiprocessor systems, microprocessor-based systems, set top boxes, programmable consumer electronics, network PCs, minicomputers, mainframe computers, and distributed computing environments to perform certain aspects of the disclosure.

In some instances, aspects of the disclosure may be implemented using computer-executable instructions, such as program modules, being executed by a computer. Such program modules may include routines, programs, objects, components, data structures, or the like that perform particular tasks or implement particular abstract data types. Some aspects of the disclosure may also be implemented in distributed computing environments where tasks are performed by remote processing devices that are linked through a communications network. In such a distributed computing environment, one or more program modules may be located in both local and remote computer storage media including non-transitory memory storage devices, such as a hard disk, random access memory (RAM), and read only memory (ROM).

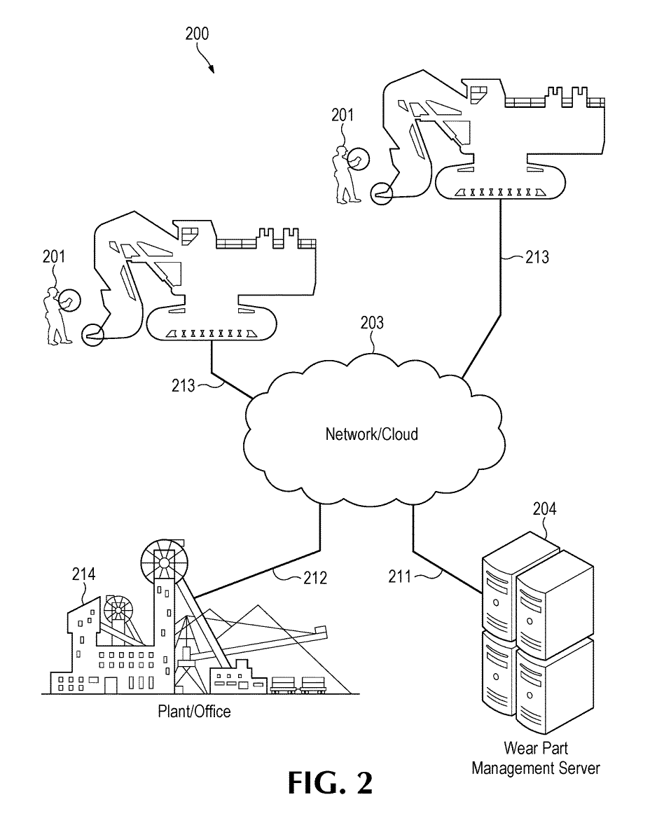

Referring to FIG. 2, a system 200 for implementing aspects of the disclosure is shown. As illustrated, system 200 may include one or more network devices. Mobile devices 201 (e.g., iPad™, iPhone™, Android™, etc.) may represent one or more mobile user devices configured to capture image data (e.g., via a camera, etc.) associated with ground engaging tools at a particular excavation site and to transmit the image data and associated information to server 204. The mobile device may comprise at least one processor, a user interface, a camera or other imaging device, a communication interface to communicate over a wireless communication link, and memory storing computer-executable instructions to perform the various steps discussed herein. The system may be single-user or multi-user. In the multi-user environment, multiple authorized users may have access to data captured, as discussed herein, by any authorized user at the site. Multiple users may be linked together by the system such that information and data captured by one user is accessible and usable by another user operating at different times, on different machines, at different mine sites, etc. The information and data may also be shared to remote locations (e.g., the mine offices, product supplier, etc.) where it may be assessed, i.e., from one or all the users of mobile devices, to determine wear, wear rate, remaining life, abrasiveness of the ground, machine usage, product and/or operation problems, etc. The information and data may optionally be used offline to make profile assessments, problem solving, consider potential design changes to improve product and operational performance, and the like. The results from such assessments can optionally be provided back to the mobile device, mine office or other person.

Mobile devices 201 may be local or remote, and are connected by one or more communications links to computer network 203 that is linked via communications links to ground engaging tool management server 204. In certain embodiments, mobile devices 201 may run the same or different algorithms as used by server 204 for analyzing image data showing ground engaging tools associated with excavating equipment, and/or, mobile devices 201 may be data stores for storing reference image data of ground engaging tool items. In system 200, ground engaging tool management server 101 may be any suitable server, processor, computer, or data processing device, or combination of the same.

Computer network 203 may be any suitable computer network including the Internet, an intranet, a cloud environment, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 211-213 may be any communications links suitable for communicating between network devices 201 and server 204, such as network links, dial-up links, wireless links, hard-wired links, etc.

Plant or office 214 may be a central or remote location for, e.g., a mine, which may also receive and house information from the mobile devices 201 and server 204.

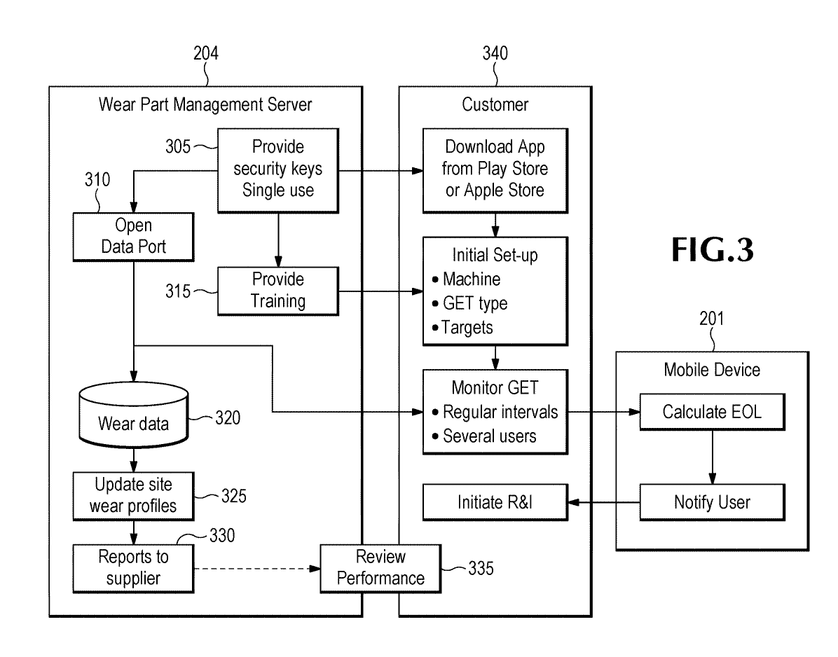

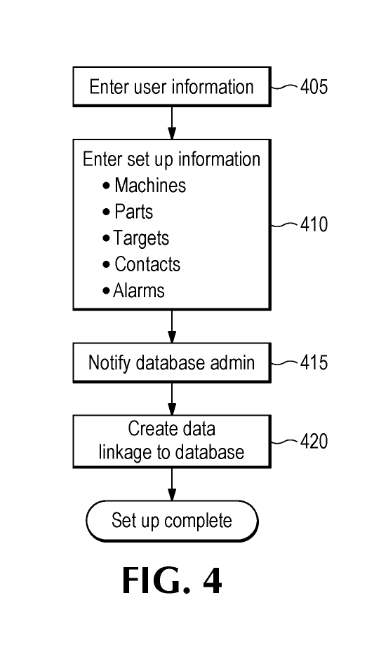

FIG. 3 is another illustration of the ground engaging tool management server 204 and the mobile device 201 and steps performed by these components. The mobile device 201 stores and/or executes an application that manages the operation of the device in accordance with one or more aspects of the disclosure. As discussed further relative to FIGS. 4-6, a user 340 associated with a mobile device downloads and installs the application and performs an initial setup of the various excavating equipment at a site that will be monitored.

Upon installation, the ground engaging tool management server 204 will send, communicate, and/or otherwise provide security keys to the mobile device 201 (step 305) and open appropriate data ports (step 310) for the intake of ground engaging tool data. Upon initial setup, the ground engaging tool management server 204 may send, communicate, and/or otherwise provide initial training materials to the mobile device 201 (step 315). Alternatively, the training materials may be part of the downloaded application.

The user may periodically utilize the mobile device 201 to perform routine checks of the ground engaging tools associated with the excavating equipment. The ground engaging tool management server 204 may receive and/or collect, from the mobile device, information associated with the equipment checks, wear profiles of the excavating equipment at the site, and/or generate and/or send notifications regarding the end-of-life conditions of various ground engaging tools. In some instances, the mobile device 201 and/or the application executed on the mobile device 201 may be configured to determine end-of-life conditions and generate and/or present notifications regarding such end-of-life conditions to the user of the device. In response to the end-of-life notifications, the user may initiate removal and installation of the ground engaging tool.

The ground engaging tool management server 204 may store wear data it receives in database or memory 320 and update the wear profiles (step 325) of the various wear devices being monitored. Optionally, the ground engaging tool management server 204 will issue reports (step 330) of the wear profile information to the supplier so that the supplier and/or the ground engaging tool management server may actively monitor use and/or wear of specific parts and predict, forecast, and/or otherwise determine replacement parts needs at the mine site. Periodically, the ground engaging tool supplier may review performance (step 335) of the ground engaging tools based on the collected data. The ground engaging tool management server 204 may review the analytics on the wear rates for each machine and review whether the targets need to be changed.

Depending on the embodiment, the disclosed components of ground engaging tool management server 204 may be associated with a single location or may be distributed across different locations and entities. For example, the systems and modules providing security keys (305), providing training (315) and conducting review performance (335) may be aspects situated at the site of ground engaging tool use (e.g., a mine), a facility of the ground engaging tool supplier and/or other location. Similarly, the systems and modules opening data ports (310), storage of wear data (320), updating wear profiles (325) and reporting to the supplier (330) may be situated locally at the mine site or the mining company's back office.

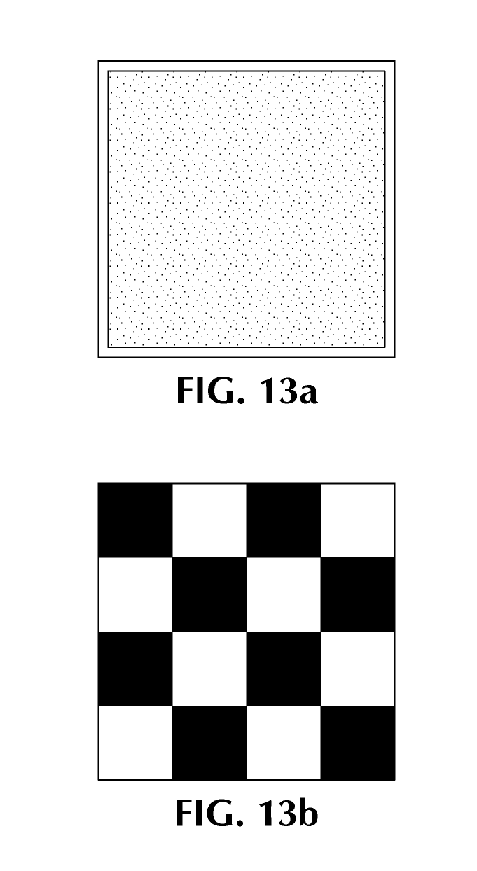

In accordance with aspects of the disclosure, a user of a mobile device 201 (e.g., mobile phone, personal digital assistant (PDA), etc.) may be used to document installation or take one or more photos (or videos) associated with a ground engaging tool. The user may place a calibration device (discussed herein) (e.g., FIGS. 13a and 13b) adjacent to or on the ground engaging tool and capture one or more images (e.g., photos) that the ground engaging tool and optionally the calibration device. The images associated with the ground engaging tool may include a top and/or side view so that an extent of wear can be determined. Ultimately, the user may take capture a number of images including multiple angles/close-up shots of the ground engaging tool and, optionally, of an identification number associated with the excavating equipment (e.g., a machine identification number, etc.). The images can also optionally be used to study wear patterns, damage, etc. on the ground engaging tools.

In one embodiment, once the user has captured an image, the application may display the image (e.g., of the ground engaging tool and calibration device) and may overlay edge markers over the image. The edge markers are indicative of a dimension of the ground engaging tool. The edge markers may, for example, indicate the overall length (or other dimension) of the ground engaging tool from distal end to proximal end. The application may allow the user to adjust one or both edge markers to more accurately represent the overall dimension being represented by the edge markers (e.g., overall length). The edge markers may be automatically set at the edges of the ground engaging tool image and optionally fine-tuned by the user, one edge marker may be automatically set and the other positioned by the user, or the edge markers may both be set at the edges of the ground engaging tool image by the user. In one embodiment, the user may adjust the one or more edge markers directly on the display using his/her finger or with the aid of a stylus to more accurately reflect the corresponding dimension of the ground engaging tool. The display may magnify the view of a portion of the image including one of the markers and one of the opposite edges for the user to more accurately adjust the marker to overlie the corresponding edge of the ground engaging product in the image on the display. The magnified image may be shown on the entire display or a part of the display. The magnification may be initiated by, for example, tapping the screen twice at the location for the desired magnification; of course, other means of initiating the magnification can be done. The magnification can be used to set one or both markers. Manual adjustment of the edge markers allows users to employ their independent judgment as to the actual positions for the opposite edges. In some operations (e.g., a mine), visibility of the edges may be obscured on account of debris, weather, lighting, etc. to make automatic setting of the edge markers by software potentially difficult and/or unreliable. Multiple pairs of edge markers can be provided to determine different dimensions, which may, for example, determine length and thickness of a ground engaging tool in a captured side view image. As discussed, this adjustment of the edge markers may take place at a later time when it may be more convenient for the user to make adjustments.

In another embodiment, the user may measure one or more of the dimensions of interest (e.g., the length of the ground engaging tool) and input the dimensions into the system via the mobile device. The user may measure the ground engaging tool by tape measure, electronic device or other means. The dimension(s) can be inputted by the user, transmitted to the mobile device, or by internal processes in the mobile device if used to electronically measure the tool. The information may be inputted by speaking to the mobile device using speech recognition software or recording the speaking on the mobile device for later use. The inputted dimension(s) may be used in lieu of or in addition to the calibration device and/or edge markers. The measured dimension and/or calibration device can be used to provide the captured image with a scale usable to determine the dimension(s) of interest and/or calculate the extent of the wear and/or an estimate of when the fully worn condition will be reached. The edge markers may optionally identify the terminal locations of the inputted dimension(s) and/or the orientation of the dimensions being inputted (e.g., the length of the ground engaging tool). The inputted dimensions (with or without other information obtained by the mobile device, e.g., the calibration device and/or measurements made with the edge markers) may be used to monitor and assess the ground engaging tool including, for example, the ground engaging tool length, the level of wear, and remaining wear life. The measured dimension(s) may also or alternatively be used as the dimension by which the extent of the wear and/or the estimate of the fully worn condition are calculated with or without the edge markers and/or calibration device.

Optionally, once the user is satisfied that the appropriate images have been captured, the application on the mobile device may analyze the images to determine if they meet a predefined set of criteria (e.g., image focus, correct angles, etc.) for completeness, accuracy, etc. If the images do not meet the minimum criteria, the application may transmit a message (e.g., via a feedback loop), informing the mobile device that alternative and/or additional images must be captured.

The application may then analyze the images to generate an output, including information relating to an extent of wear and/or an estimated end-of-life. In an alternative embodiment, the user may transmit the images from the mobile device to the ground engaging tool management server (discussed above) and the ground engaging tool management server may perform the calculations.

FIGS. 4-6 detail more specifically the steps performed in accordance with embodiments of the disclosure. These steps that follow in the figures may be implemented by one or more of the components in FIGS. 1 and 2 and/or other components, including other computing devices.

FIG. 4 is a flow diagram of an initial setup process for the ground engaging tool management program on the mobile device 201. At step 405, mobile device 201 receives user information from the user of mobile device 201. At step 410, mobile device 201 receives site setup information. This information may be inputted by the user, received from sensor(s) in the ground engaging tool and/or machine, and/or from scanning a code provided on the equipment or in the cab of the machine, and/or speaking to the mobile device using speech recognition software or recording for later use or input. The information may include such data as, for example, identification of the ground engaging tool, the machine on which the ground engaging tool is attached, when the ground engaging tool was attached, the number of hours in operation, the locations with the mine site where the ground engaging tool was worked, and the like. In addition, the mobile device 201 may receive, for example, information identifying the various excavating equipment or machines at the site, information identifying the ground engaging tools associated with each machine and/or current and/or previous wear levels of such ground engaging tools, specific targets or limit lengths set by the user to indicate the end-of-life of the ground engaging tool (which can vary by part, position, machine, and location), contacts or key stakeholders at the mine site to be notified when an alarm is triggered, and/or information identifying one or more alarms and/or alarm triggers that the user would like mobile device 201 to generate and/or use.

Once the mobile device receives the setup information, at step 415, mobile device 201 (i.e., the application executing on mobile device 201 or elsewhere and communicating with the mobile device) may generate and send a notification to the ground engaging tool management server 204 indicating that the device has been configured. At step 420, the ground engaging tool management server 204 may establish a communication link between mobile device 201 and the wear database 320 for the particular site.

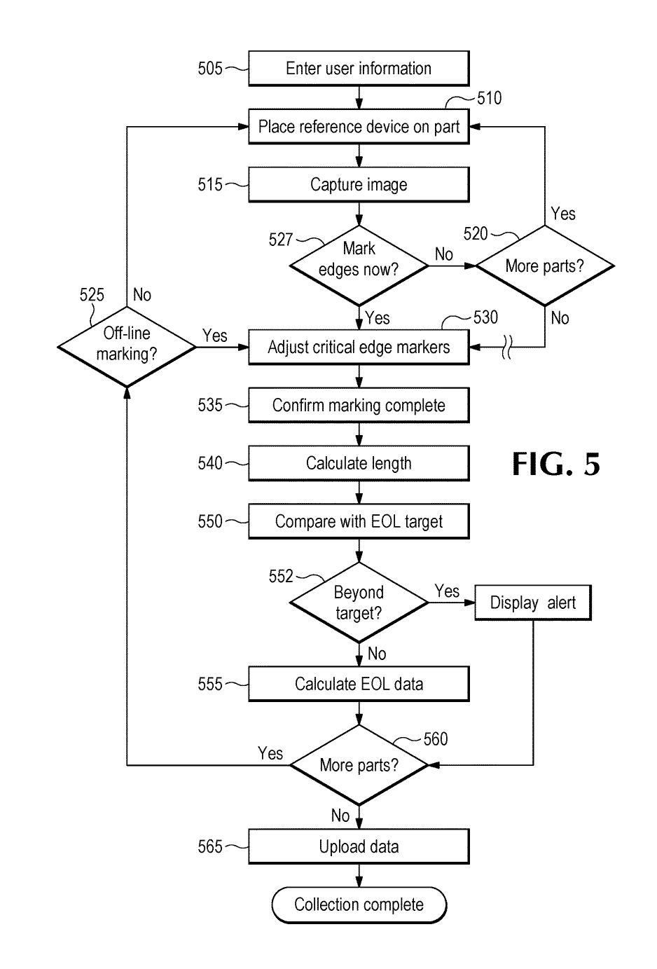

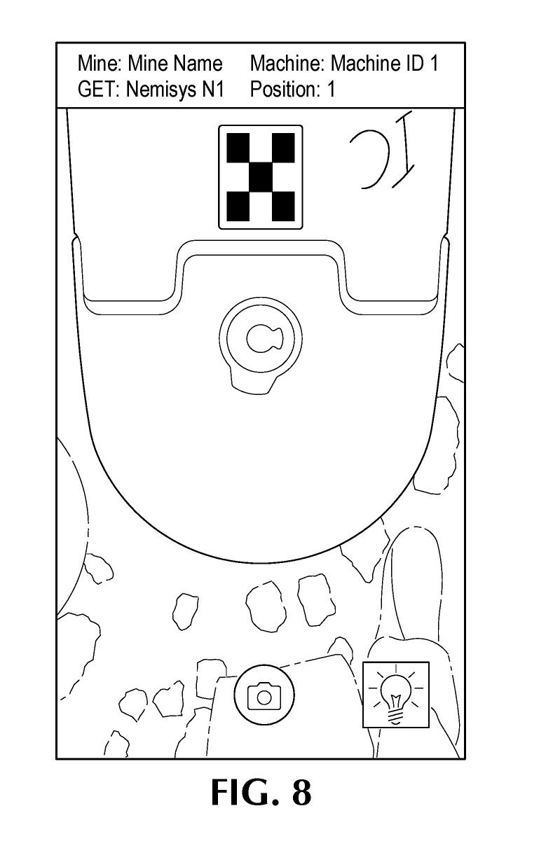

FIG. 5 is a flow diagram illustrating the steps associated with capturing of wear data by the mobile device 201 in one embodiment. At step 505, mobile device 201 may begin executing an application implementing one or more aspects of the disclosure (e.g., when the user of mobile device 201 is ready to initiate the system, he/she may launch the application and enter user-information). At step 510, the user of mobile device 201 may optionally place a calibration device near the ground engaging tool to be imaged. The calibration device may be a unique device such as the square or checkboard style shown in FIGS. 8, 9, 13a and 13b, or a standard general item such as a company business card. The calibration device can be magnetic, provided with adhesive, or secured by separate means such as tape, a strap or other means. In certain situations (e.g., a top view) the calibration device may simply be set on the ground engaging tool. The calibration device may also be held on or near the ground engaging tool to be captured with the image of the ground engaging tool. Preferably, the calibration device is placed relative to the dimension of the ground engaging tool being imaged. For example, if the user is seeking to take an image of the top view of the ground engaging tool (e.g., FIG. 8), the calibration device is placed such that it can be similarly imaged. The calibration device may, for example, alternatively (or successively) be placed along the side of the ground engaging tool for images of a side view of the ground engaging tool.

At step 515, using the imaging device (e.g., a camera) of mobile device 201 and based on input from the user of mobile device 201, mobile device 201 may capture an image of the ground engaging tool and optionally also the calibration device. The system may leverage the calibration device to determine the scale and pose of the ground engaging tool image. Alternatively, an actual measurement (such as of the ground engaging tool length) can be taken and entered into the mobile device, e.g., by the user. The measurement can be in lieu of the calibration device, or as an additional verification of the scale determined by the calibration device.

The mobile device may then display a user interface that includes the captured image of the ground engaging tool and, if included, the calibration device. In one embodiment, mobile device 201 may also capture GPS location information as part of the image data. Wear rates may vary depending on location that the ground engaging tool is being used. GPS data may also be provided by a sensor(s) in the ground engaging tools and/or associated earth working equipment. Location data may also be inputted by the user or obtained by other means. In certain geographic locations, excavating conditions may be more compact, harder or otherwise more abrasive resulting in greater wear rate of the ground engaging tool. Thus, by capturing “point of use” data, e.g., via GPS location of the part, the system may make more accurate wear rate determinations.

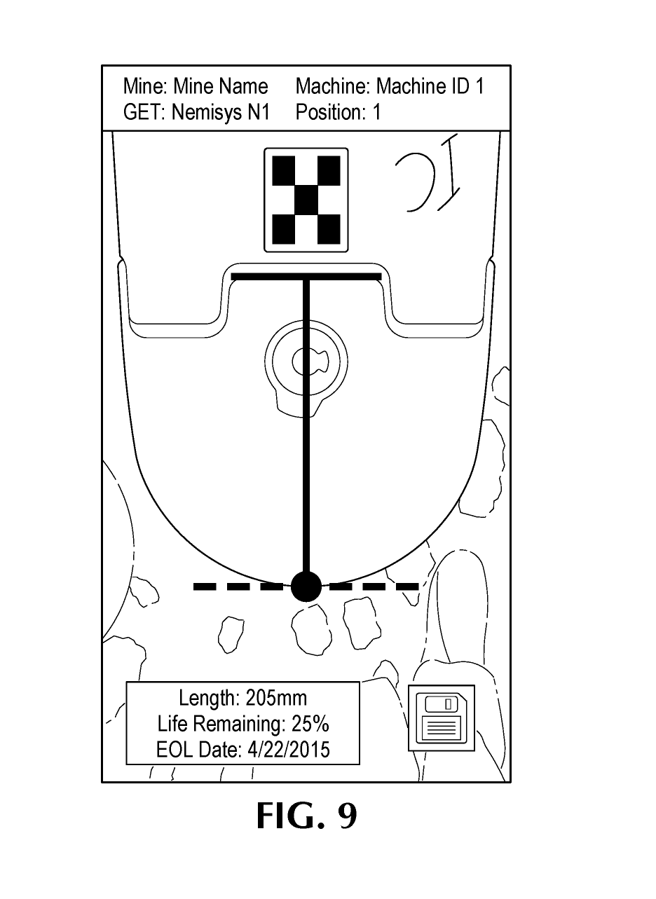

At step 527, mobile device 201 may optionally present a notification prompting the user as to whether or not mobile device 201 should mark one or more edges of the ground engaging tool. Mobile device 201 may perform edge marking to capture key dimensions of the ground engaging tool. Depending on the user's preference, this edge marking step may be performed by mobile device 201 upon capture of each image (i.e., contemporaneous with capturing the image), performed after multiple images are captured, or at a later time. In one embodiment, the user can confirm to mark one of more edges of the ground engaging tool such that mobile device 201 may display at least one set of edge marker that are overlaid over the image of the ground engaging tool. In any event, these edge markers serve to indicate a dimension of the ground engaging tool. In other words, the system may identify the calibration object within the image and, with reference to the scale and pose of, e.g., the calibration device, the system may determine the length between the edge markers. In one embodiment, the edges may reflect the overall length of the ground engaging tool (e.g., FIG. 9). At step 520, if the edges are not to be marked at that time, the mobile device 201 can be used to begin the process anew (at step 510) for other ground engaging parts to be monitored.

At step 530, mobile device 201 may receive user input adjusting the edge markers on the user interface presented by mobile device 201 (e.g., this may allow the user of mobile device 201 to ensure that the edge markers accurately reflect the edges of the ground engaging tool). For example, the user may adjust the edge markers using his/her finger or with the aid of a stylus to identify the edges of the part(s) being measured. Optionally, the mobile device may allow the image to be zoomed to provide better control and greater accuracy.

In one embodiment, the user may take all desired images at the site and, at a later point, return to the application to review and adjust the edge markers. This may be desirable, for example, where sun glare makes it difficult to accurately define the edge markers at the site or if cellular or data connectivity is not available at the site. Cell networks are often intermittent at mining sites. Accordingly, the mobile device may capture information off-line and synchronize with the system when cell service or WiFi connectivity becomes available.

Once the user confirms the markings are complete, step 535, the mobile device 201 may calculate the relevant dimension(s) of the ground engaging tool using, in part, the imaged dimension(s) of the calibration device and the edge markers, step 540. Alternatively, the relevant dimension(s) may be measured and inputted by the user or otherwise in the mobile device. In one embodiment, a relevant dimension is the length of the ground engaging tool. In other embodiments, the relevant dimensions may also or in lieu of include the width and/or thickness (height) of the ground engaging tool. These dimensions can be indicative of the extent of wear of the ground engaging tool. The mobile device 201 then, at step, 550, may compare the relevant dimension(s) of the ground engaging tool with the corresponding dimension(s) of the ground engaging tool when it is new and/or at the end of its life. At step 552, a notification or alert can be generated if the detected level of wearing is at or beyond the fully worn condition such that the ground engaging tool should be immediately replaced, i.e., while the machine is currently down. At step 555, the mobile device 201 may calculate an estimated end-of-life date of the ground engaging tool, typically in the form of calendar days.

End-of-life determinations may be made in a number of ways depending on the application or the ground engaging tool. For example, in one embodiment, the calculation may be a regression or other analysis based on installation date and each of the lengths measured on multiple dates to the end of life. The end-of-life calculation at any given time may incorporate prior measurements or calculations made from one or more prior points in time. The analysis may include seasonal, location, and positional factors as inputs to the analysis. Another input may include machine run-time information for a more accurate end-of-life measure. The amount of time that a machine is being used may indicate that the ground engaging tools are being used and experiencing wear. During the period that a machine is down (e.g., for preventive maintenance) and not operating, that time may or may not be counted in the end-of-life calculation.

In another embodiment, the end-of-life calculation may be based on a look-up table that correlates a dimension (e.g., length) of a particular ground engaging tool to an extent of wear and an amount of days remaining to end-of-life for the ground engaging tool.

The system may refine and better predict the end-of-life date calculation as wear information is taken at multiple points in time. For example, the system may assume a default rate of wear but as more data points are gathered, the system may adjust the rate of wear for the particular site, particular machine, and/or particular tooth. Depending on the rate of wear determined by the multiple data points, the end-of-life date determination may be sooner or later than the original default date. In an embodiment, these calculations are made by the mobile device 201. However, in an alternative embodiment, the calculations could be made by the ground engaging tool management server 204 and communicated back to the mobile device 201. In all operations of this system, the calculations and/operations can be done by the mobile device 201 or the management server 204 and/or other means and communicated to the mobile device.

The system may display any of the information to the user on the user interface of the mobile device 201 including, for example, the calculated dimension of the ground engaging tool, the percentage of wear, the percentage of wear remaining, the estimated end-of-life date, etc. At step 560, this process may be repeated for each ground engaging tool that is to be monitored or checked. At step 525, the edge markers can be adjusted before or after beginning at step 510 for the next ground engaging tool. At step 565, the mobile device 201 may upload all or some of the information it gathered and its calculations during this process. The system may also use information gathered from sensors in the ground engaging tools and/or the earth working equipment.

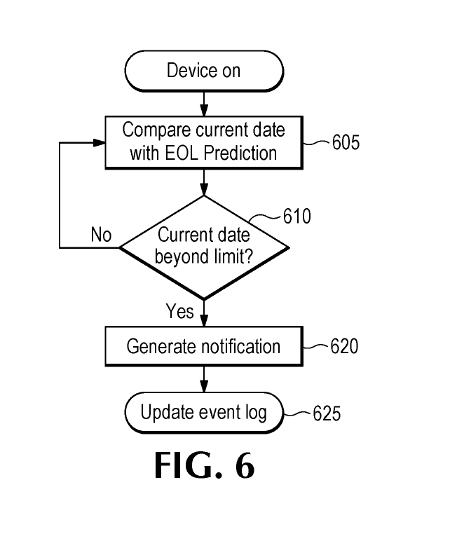

FIG. 6 is a flow diagram illustrating steps, in one embodiment, associated with generating alerts or notifications to the user of potential end-of-life conditions. Once mobile device 201 has made end-of-life determinations for one or more ground engaging tools, the mobile device 201 may set-up one or more alerts to alert the user of the mobile device 201 or a computing system at the plant site 214 to warn of potential needs to replace the ground engaging tools. Again, these steps may be performed by the mobile device 201 or the ground engaging tool management server 204. At step 605, the mobile device 201 may compare the calculated end-of-life date(s) with the associated one or more ground engaging tools with the current date. At step 610, the mobile device 201 may perform a check if the current date is at or beyond a certain limit. The limit could be set by the user or the mobile device 201. For example, the mobile device 201 may be set to issue a warning five days before the estimated end-of-life date of a ground engaging tool. If the limit has been reached, at step 615, the mobile device 201 may issue a notification to the relevant personnel. The notification may be in the form of an audible alert and/or visual alert on the mobile device 201 that is set for a specific time of day (e.g., the start of the user's morning shift at the work site). The notifications may be dependent on the scheduled times of maintenance or repair, i.e., for example, whether the expected end-of-life date is before or after the next scheduled downtime for the machine. The alerts or notifications could also be sent every time or on certain times the ground engaging tool is imaged or monitored. The alert may be sent when the time to the fully worn condition is estimated to be less than a certain time period, between capturing the image and the next scheduled downtime for the earth working equipment, a certain number of days following capturing the image, within a certain percentage of the fully worn condition, and/or by other factors.

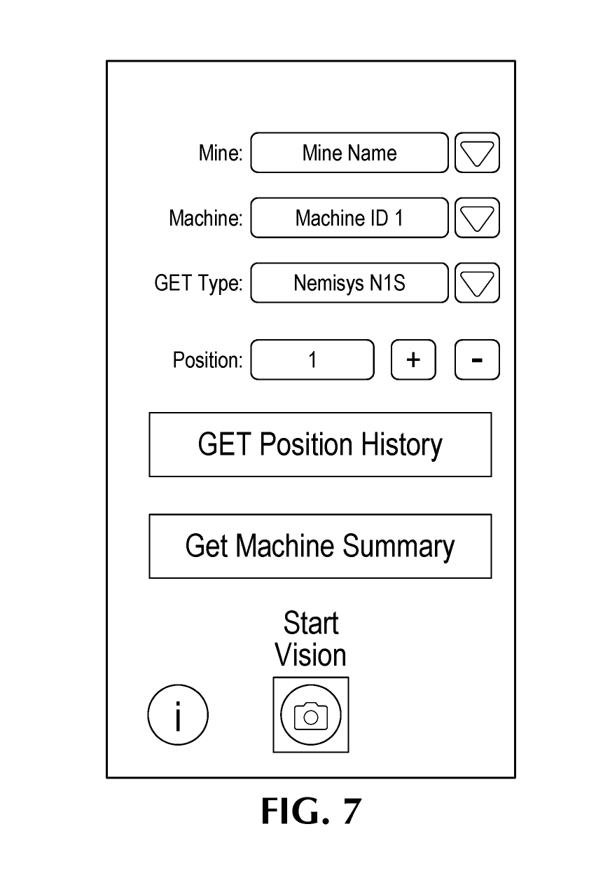

FIGS. 7-12 show exemplary screen shots of the user interface of the mobile device 201 during the process of setup and image capture of a ground engaging tool in accordance with certain aspects of the present disclosure. At initial set up, the mobile device 201 may receive basic information from the user relating to the ground engaging tools being monitored. In the set up screen, the user may identify the particular mine and the machine(s) at the mine. Each machine may utilize multiple ground engaging tools at various positions of the machine. Accordingly, the user may specify the type of ground engaging tool being used at each unique position of the machine. The user may also specify the number of days prior to end-of-life the user prefers to receive a notification. Alternatively, sensors, scans or other means may provide all or some of this kind of information to the mobile device in lieu of or in cooperation with the user inputting the information.

The user may gather information relating to the ground engaging tools. Starting with the FIG. 7 example, the user specifies the particular job site or mine, the machine in question, the type of ground engaging tool (or ground engaging tool (GET)) and the position of the ground engaging tool on the machine. These parameters may be edited using, for example, drop down menus. The information related to the ground engaging tools, earth working equipment, working site, etc. may be provided by sensors in the ground engaging tools and/or the earth working equipment, and/or inputted by scanning a code provided on the ground engaging tools and/or earth working equipment. Once the user specifies this information, the user may proceed to taking the images, for example, by pressing a camera icon on the screen.

With reference to the FIG. 8 example, the user may capture an image of the ground engaging tool and the calibration device. In this example, the image is a top view image of the wear member that is associated with machine ID “1” and the ground engaging tool that is a “Nemysis N1” type in position “1” of the machine. The image also includes the calibration device that was placed adjacent the proximate edge of the wear member. FIG. 9 is the same image but with edge markers displayed over the wear member. In this example, the edge markers extend from the proximal edge (solid line) to the distal edge (dashed line) of the wear member. Using the user interface on the mobile device, the user may adjust the edge markers to accurately conform to the edges of the wear member. Once satisfied, the user may save the image and edge markers so that some or all of the information may be uploaded to the ground engaging tool management server 204. Also as shown on FIG. 9, the user interface may display calculated information relating to the ground engaging tool including, for example, the length of the ground engaging tool, the percentage of remaining life of the ground engaging tool, and/or the date at which the part will be at its end-of-life.

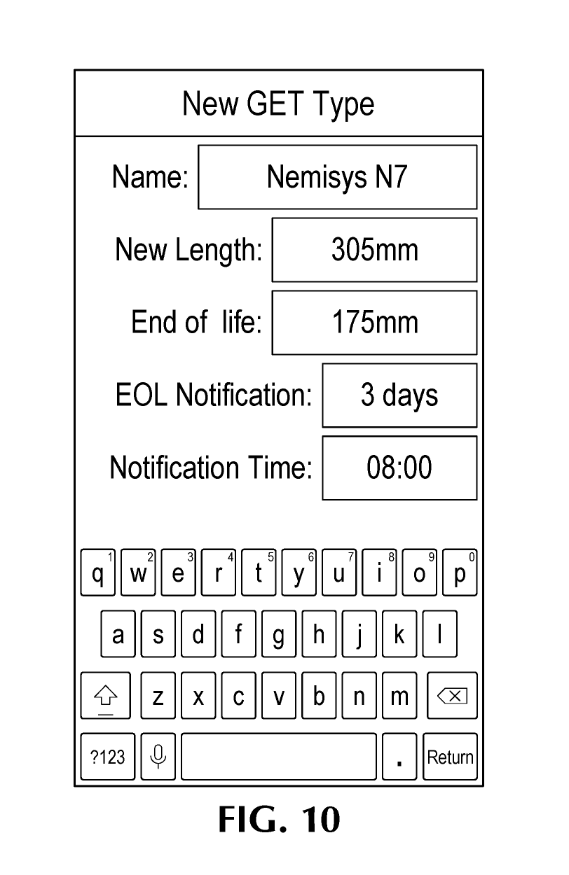

FIG. 10 shows an example of a display screen for setting up a new type of wear member (or GET). The user may enter the new and worn lengths of the new type of wear member. Based on these measured lengths, the system may calculate the wear life percentage. The end-of-life notification may be a time that is established by the user when to send a push notification (for example in terms of days in advance and time of day).

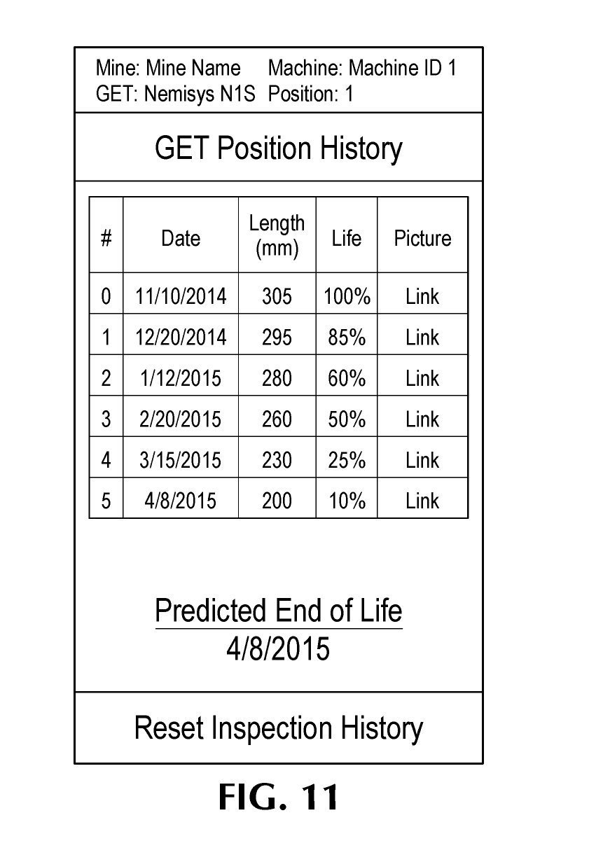

FIG. 11 is an example of a history page for a particular wear member. For any wear member, the system may provide a history of the inspection details including, for example, for each inspection, the date of the inspection, the calculated length of the ground engaging tool, the remaining life, and a (popup) picture of the ground engaging tool at the time of inspection. An end-of-life prediction may be included based on the start date, current date, current measurement, scheduled downtime for the machine, location within the mine site and/or other factors. In an embodiment, the system may refine the predicted end-of-life based on the prior inspections and the rate of wear that is determined for that wear member.

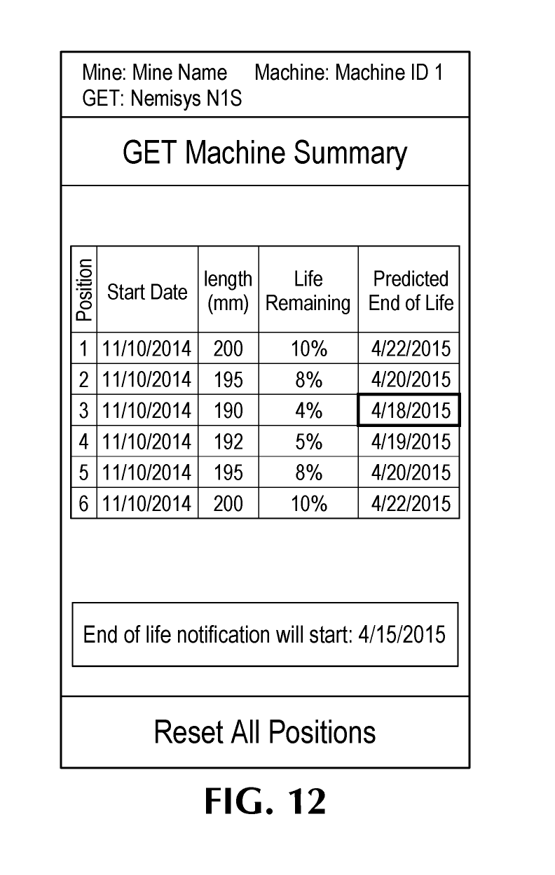

FIG. 12 is an example of a summary screen for a particular machine. This screen provides the user current information for all positions on the machine at one time. The “Reset All Positions” button may reset all of the positions history to a single inspection with 100% and the current date. This summary screen may provide the user with a high-level view of all of the conditions of all of the ground engaging tools on the machine. In this example, since the user set the notifications to start at a predetermined interval (e.g., 3 days) before the end-of-life, the user is notified that the end-of-life warning notifications will start on Apr. 15, 2015 as dictated by the most worn out wear member.

FIG. 13a is an illustration of an example of a calibration device, which can be a simple square defined by a color or line. Alternatively, a checkerboard-style calibration device could be used (FIG. 3b). It will be appreciated that the calibration device can take any form and, e.g., could have any known shape or pattern. In the illustrated embodiments, the patterns have known dimensions which allow the system to scale the image of the ground engaging tool in accordance with the image of the calibration device. The system can also determine whether the shape or pattern is square to the mobile device and make appropriate adjustments in making the various determinations and assessments.

In accordance with the embodiments disclosed herein, the information gathered by mobile device 201 may be uploaded to the ground engaging tool management server 204, which may be accessible by the plant/office 214. The plant/office and/or ground engaging tools supplier may thereby determine demand and predict potential need to replenish ground engaging tools to the site. With data from multiple sites and customers, the supplier may also better determine the best range of ground engaging tool lengths that correlate to optimum performance.

In another embodiment, end-of-life targets for ground engaging tools may be adjusted according to the customer or job site. For example, the end-of-life limits may be variable according to the geographic location of the site (where soil conditions may dictate when the ground engaging tools should be replaced), preferences of the customer, etc.

In another embodiment, the end-of-life of a ground engaging tool may be determined by date that the ground engaging tool was installed or replaced. The system may capture the date/time of each tooth change by each position on a machine. By leveraging a database (developed over time) of the wear rates by position, machine, operator, and/or GPS location, the system could calculate an end-of-life based on a certain number of days from initial installation. Many of the same screens discussed herein may be used for input, synchronizing, and alerts. Such an approach may not require images be captured by the user (or at least not as frequently). For example, the system may only need information when a ground engaging tool is changed. Moreover, this approach may not require the use of a calibration device and may allow for tracking of all ground engaging tools.

The foregoing descriptions of the disclosure have been presented for purposes of illustration and description. They are not exhaustive and do not limit the disclosure to the precise form disclosed. Modifications and variations are possible in light of the above teachings or may be acquired from practicing of the disclosure. For example, the described implementation includes software but the present disclosure may be implemented as a combination of hardware and software or in hardware alone. Additionally, although aspects of the present disclosure are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM or ROM.

One or more aspects of the disclosure may be embodied in computer-usable data or computer-executable instructions, such as in one or more modules, executed by one or more computers or other devices to perform the operations described herein. Generally, modules include routines, programs, objects, components, data structures, and the like that perform particular operations or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, mobile device, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A process for monitoring a ground engaging tool secured to earth working equipment, the process comprising:
capturing an image of the ground engaging tool secured to the earth working equipment and subjected to wearing with a mobile device having an imaging device and a user interface including a display;
showing the captured image on the display;
determining a dimension of the ground engaging tool subject to wear;
operating at least one processor and memory storing computer-executable instructions to access dimension data from a database of at least a dimension of the ground engaging tool in a fully worn condition corresponding to the determined dimension, and use the dimension data and determined dimension to calculate at least one result including the extent of wearing experienced by the ground engaging tool and/or an estimate of when the ground engaging tool will reach a fully worn condition; and
communicating the at least one result to the user on the display.

2. The process of claim 1 including:
operating the at least one processor and memory storing computer-executable instructions to determine a rear edge of the ground engaging tool in the captured image, and show edge markers on the display with the captured image with one said edge marker aligned with the rear edge of the ground engaging tool in the captured;
the user adjusting the other edge marker to align with a point farthest forward on the ground engaging tool in the captured image; and
operating the at least one processor and memory storing computer-executable instructions to use the distance between the edge markers to determine the dimension of the ground engaging tool.

3. The process of claim 2 including measuring a dimension of the ground engaging tool, inputting the measured dimension into the mobile device, and operating the at least one processor and memory storing computer-executable instructions to use the measured dimension to determine a scale of the captured image and with the edge markers determine the dimension of the ground engaging tool.

4. The process of claim 3 including sending an alert when the fully worn condition is estimated to be less than a certain time period.

5. The process of claim 4 wherein the time period is the time between capturing the image and the next scheduled downtime for the earth working equipment.

6. The process of claim 4 wherein the time period is a certain number of days following capturing the image.

7. The process of claim 3 including sending an alert when the extent of wear is within a certain percentage of the fully worn condition.

8. The process of claim 2 including placing a calibration device near the ground engaging tool such that the calibration device is included in the captured image of the ground engaging tool, and operating the at least one processor and memory storing computer-executable instructions to use the calibration device in the captured image to determine a scale of the captured image, and use the scale to determine the dimension of the ground engaging tool.

9. The process of claim 1 including operating the at least one processor and memory storing computer-executable instructions to show edge markers on the display with the captured image, the user adjusting the edge markers to align them on opposite edges of the ground engaging tool in the captured image, and operating the at least one processor and memory storing computer-executable instructions to use the distance between the edge markers to determine the a dimension of the ground engaging tool.

10. The process of claim 1 including measuring a dimension of the ground engaging tool and providing the measured dimension to the mobile device as the determined dimension of the ground engaging tool.

11. The process of claim 1 including receiving information regarding the ground engaging tool from at least one sensor in the ground engaging tool, and showing the information on the display.

12. The process of claim 11 wherein the information includes the kind of ground engaging tool and/or its position on the earth working equipment.

13. The process of claim 1 including using the mobile device to transmit the at least one result to a remote server or database.

14. The process of claim 1 wherein the estimated fully worn condition is determined based on wear information obtained at multiple points in time.

15. The process of claim 1 wherein the estimated fully worn condition is determined based on information pertaining the ground conditions where the ground engaging tool is being used.

16. A process for scheduling replacement of a ground engaging tool secured to earth moving equipment, the process comprising:
capturing an image of the ground engaging tool secured to the earth working equipment and subjected to wearing with a mobile device having an imaging device;
showing the captured image on the display;
determining a dimension of the ground engaging tool subject to wear;
operating at least one processor and memory storing computer-executable instructions to access dimension data from a database of at least a dimension of the ground engaging tool in a fully worn condition corresponding to the determined dimension, and use the dimension data and determined dimension to calculate at least one result including the extent of wearing experienced by the ground engaging tool and/or an estimate of when the ground engaging tool will reach the fully worn condition; and
using the at least one result to schedule when to replace the ground engaging tool secured to the earth working equipment.

17. The process of claim 16 including:
operating the at least one processor and memory storing computer-executable instructions to determine a rear edge of the ground engaging tool in the captured image, and show edge markers on the display with the captured image with one said edge marker aligned with the rear edge of the ground engaging tool in the captured image;
the user adjusting the other edge marker to align with a point farthest forward on the ground engaging tool in the captured image; and
operating the at least one processor and memory storing computer-executable instructions to use the distance between the edge markers to determine the dimension of the ground engaging tool.

18. The process of claim 17 including measuring a dimension of the ground engaging tool, operating the at least one processor and memory storing computer-executable instructions to use the measured dimension to determine a scale of the captured image, and using the scale to determine the dimension of the ground engaging tool.

19. The process of claim 17 including placing a calibration device near the ground engaging tool such that the calibration device is included in the captured image of the ground engaging tool, operating the at least one processor and memory storing computer-executable instructions to use the calibration device to determine a scale of the captured image, and using the scale to determine the dimension of the ground engaging tool.

20. The process of claim 16 including measuring a dimension of the ground engaging tool, and operating the at least one processor and memory storing computer-executable instructions to use the measured dimension as the determined dimension to calculate the at least one result.

21. A process of monitoring a ground-engaging ground engaging tool secured to earth working equipment, the process comprising:
capturing, via an imaging device on a mobile device, an image comprising the ground engaging tool secured to the earth working equipment;
displaying, via a user interface on the mobile device, the captured image of the ground engaging tool, and edge markers overlying the captured image of the ground engaging tool to indicate a dimension of the ground engaging tool;
receiving input, via the user interface, to adjust at least one of the edge markers;
updating the display of at least one edge marker based on the received input; and
calculating, by the mobile device, an extent of wear of the ground engaging tool based in part on information from the edge markers.

22. The process of claim 21 including displaying, via the user interface, a predicted end-of-life date of the ground engaging tool based on at least dimension indicated by the edge markers.

23. The process of claim 22 including issuing an alert via the mobile device a preset time before the predicted end-of-life of the ground engaging tool.

24. The process of claim 21 comprising displaying the extent of wear of the ground engaging tool based on the user interface.

25. The process of claim 21 wherein the predicted end-of-life date is determined based on wear information obtained at multiple points in time.

26. The process of claim 21 including measuring a dimension of the ground engaging tool and using the measured dimension with the information from the edge markers to calculate the extent of wear.

27. The process of claim 21 including capturing via the camera a calibration device in the image, and using the calibration device with the information from the edge markers to calculate the extent of wear.

28. A process for scheduling replacement of ground engaging tools for earth working equipment, the process comprising:
(a) capturing information on when a ground-engaging ground engaging tool is installed on the earth working equipment at a certain position, and when the ground-engaging ground engaging tool is removed from the earth working equipment;
(b) identifying the earth working equipment and the position of the ground-engaging ground engaging tool on the earth working equipment;
(c) repeating steps (a) and (b) for successive ground engaging tools installed at the same position on the same machine;
(d) using the captured information to calculate an average time period the ground engaging tools are in use; and
(e) using the average time period to schedule when the next ground engaging tool should be installed on the earth working position at the position.

29. The process of claim 28 including at least once using a mobile device including at least one processor, a user interface, a camera and memory storing computer-executable instructions that, when executed by the at least one processor, causes the mobile device to (i) capture, via the camera, an image including the ground engaging tool secured to the earth working equipment, (ii) determine opposite edges of the ground engaging tool in the image and the distance between the opposite edges, (iii) calculate a level of wear present in the ground engaging tool using the distance between the determined edges, the edge markers, and at least one calculated level of wear of the ground engaging tool from a prior point in time, and (iv) use the calculated level of wear to schedule when the ground engaging tool should be replaced.

30. The process of claim 29 including capturing information about the abrasiveness of the ground engaged by the ground engaging tool and using the abrasiveness information in the scheduling of when the ground engaging tool should be replaced.

31. A process for monitoring a ground engaging tool secured to earth working equipment, the process comprising using a mobile device to capture an image of the ground engaging tool, showing on a display of the mobile device the captured image and electronically generated markers, setting the markers to overlie opposite edges of the ground engaging tool in the captured image, calibrating the image to determine the relationship between a first distance extending between the markers on the display and a second distance extending between the opposite edges of the ground engaging tool, calculating the first and second distances, and using data on at least the fully worn condition of the ground engaging tool to determine an extent of wear in the ground engaging tool and/or an estimate of when the fully worn condition of the ground engaging tool will be reached.

32. The process of claim 31 wherein at least one of the markers can be manually adjusted on the mobile device display to overlie one of the opposite edges.

33. The process of claim 32 wherein manual adjustment of at least one of the markers is accomplished by contacting the display where the marker is shown, moving along the display to a location where the marker is desired, and removing the contact with the display.

34. The process of claim 31 wherein both of the markers can be manually adjusted on the mobile device display to overlie the opposite edges.

35. The process of claim 31 wherein a calibration device is included in the captured image, data on the calibration device is compared with the calibration device in the image, and the comparison used to complete said calibrating of the image.

36. The process of claim 35 wherein the calibration device is secured to the ground engaging tool prior to capturing the image.

37. A process for scheduling replacement of a ground engaging tool secured to earth working equipment, the process comprising:
using a mobile device to capture information pertaining to wear of the ground engaging tool at a plurality of different times wherein said times of capturing information are separated from each other by a time of operation for the earth working equipment; and
operating at least one processor and memory storing computer-executable instructions to use the captured information and time lapse between the different times of capturing information to calculate the extent of wear at at least one of the times of capturing information, estimate when the ground engaging tool will reach a fully worn condition, and schedule a time when the ground engaging tool will be replaced based on the estimate of when the fully worn condition will be reached.

38. The process of claim 37 wherein a schedule of planned downtime of the earth working equipment is used by the at least one processor and memory storing computer-executable instructions to schedule the time for replacing the ground engaging tool at the last scheduled downtime for the earth working equipment before the ground engaging tool is estimated to reach the fully worn condition.

39. The process of claim 37 wherein the at least one processor and memory storing computer-executable instructions uses data regarding the abrasiveness of ground at the locations of use to estimate when the fully worn condition is reached.

40. The process of claim 37 wherein the mobile device captures an image and shows the image on a display, electronic markers are displayed over the captured image on the display and set over opposite edges of the image of the ground engaging tool on the display to determine the current length of ground engaging tool.

41. The process of claim 40 wherein the markers can be manually adjusted to overlie the opposite edges of the image of the ground engaging tool on the display.

42. A mobile device for monitoring a ground engaging tool secured to earth working equipment, the mobile device comprising:
at least one processor;
a user interface;
an imaging device; and
memory storing computer-executable instructions that, when executed by the at least one processor, causes the mobile device to:
capture, via the imaging device, an image comprising the ground engaging tool secured to the earth working equipment;
determine opposite edges of the ground engaging tool in the image and the distance between the opposite edges; and
calculate an extent of wear present in the ground engaging tool using at least the distance between the opposite edges.

43. The mobile device of claim 42 wherein the memory storing computer-executable instructions are executed by the at least one processor to display, via a user interface, the captured image of the ground engaging tool, and user-adjustable edge markers wherein the edge markers are overlaid on the ground engaging tool in the image to indicate a dimension of the ground engaging tool, receive user input adjusting a position of at least one said edge marker so that each said edge marker aligns with one of the opposite edges of the ground engaging tool, and update the display of the at least one edge marker based on the received user input.

44. The mobile device of claim 43 wherein the memory storing computer-executable instructions are executed by the at least one processor to calculate an estimated end-of life of the ground engaging tool.

45. The mobile device of claim 44 wherein the memory storing computer-executable instructions are executed by the at least one processor to issue an alert when the end-of-life of the ground engaging tool is approaching.

46. The mobile device of claim 45 including a communication interface to enable the mobile device to communicate the alert to a remote server.

47. The mobile device of claim 42 wherein the memory storing computer-executable instructions, when executed by one or more of the processors, cause edge markers to be approximately oriented over opposite edges of the ground engaging tool in the image, and cause the mobile device to allow a user to adjust at least one of the associated edge markers via the user interface to better align said at least one edge marker with one of the opposite edges as needed.

48. The mobile device of claim 42 wherein the memory storing computer-executable instructions are executed by the at least one processor to determine the scale of the image containing the ground engaging tool using a measured dimension of the ground engaging tool.

49. The mobile device of claim 42 wherein the memory storing computer-executable instructions are executed by the at least one processor to determine the scale of the image containing the ground engaging tool using a calibration device included in the captured image.

50. The mobile device claim 42 wherein the memory storing computer-executable instructions cause the mobile device to calculate an extent of wear of the ground engaging tool include identifying the edges of the ground engaging tool.

51. The mobile device claim 42 wherein the memory storing computer-executable instructions cause the mobile device to calculate an extent of wear of the ground engaging tool by using a measured length of the ground engaging tool.

52. The mobile device claim 42 wherein the memory storing computer-executable instructions cause the mobile device to calculate an extent of wear of the ground engaging tool include measuring at least one of a length, width and height of the ground engaging tool.

53. The mobile device of claim 42 wherein the memory storing computer-executable instructions, when executed by one or more of the processors, cause the mobile device to display an indication of a calculated extent of wear of the ground engaging tool.

54. The mobile device of claim 53 wherein the memory storing computer-executable instructions cause the mobile device to display an indication of a calculated extent of wear include a display of a percentage of wear remaining on the ground engaging tool.

55. The mobile device of claim 42 wherein the memory storing computer-executable instructions cause the mobile device to calculate a predicted end-of-life date include comparing wear information obtained at multiple points in time.

56. The mobile device of claim 55 wherein the memory storing computer-executable instructions cause the mobile device to display an indication of the calculated extent of wear of the ground engaging tool include a display of a predicted end-of-life date.

57. The mobile device of claim 42 wherein the memory storing computer-executable instructions, when executed by one or more of the processors, cause the mobile device to issue an alert in accordance with settings established by a user of the mobile device.

58. The mobile device of claim 42 wherein the memory storing computer-executable instructions, when executed by one or more of the processors, cause the mobile device to remotely store the image with at least one of associated date, time and location information.

59. The mobile device of claim 42 wherein the memory storing computer-executable instructions, when executed by one or more of the processors, causes the mobile device to capture GPS information as part of the image.

60. A system for monitoring a ground engaging tool secured to earth working equipment, the system comprising:
at least one processor;
a communication interface to receive information from a mobile device relating to at least one said ground engaging tool secured to the earth working equipment, wherein the received information includes at least one of an image of the ground engaging tool, calibration information relating to the ground engaging tool, and edge markers overlying the image of the ground engaging tool;
memory storing computer-executable instructions that, when executed by the at least one processor, cause the system to:
calculate an extent of wear of the ground engaging tool and/or an estimate of a fully worn condition of the ground engaging tool based in part on the received information; and
communicate at least one of the extent of wear and the estimate of the fully worn condition of the ground engaging tool to the mobile device via the communication interface; and
a user interface to receive a request to view information associated with the at least one ground engaging tool, the user interface including a display to show in response to receipt of the request, at least one of a portion of the received information, the calculated extent of wear, and the estimated fully worn condition of the ground engaging tool.

61. The system of claim 60 wherein the memory storing computer-executable instructions, when executed by one or more of the processors, determines a rear edge of the ground engaging tool in the captured image, shows edge markers on the display with the captured image with one said edge marker aligned with the rear edge of the ground engaging tool in the captured, and the user interface enables user adjustment of the other edge marker to align with a point farthest forward on the ground engaging tool in the captured image, and uses the distance between the edge markers to calculate the extent of wear and/or the estimated fully worn condition.

62. The system of claim 61 including measuring a dimension of the ground engaging tool, wherein the memory storing computer-executable instructions, when executed by one or more of the processors, uses the measured dimension to determine a scale of the captured image and with the edge markers determine the extent of the wear and/or the estimated fully worn condition.

63. The system of claim 62 wherein the memory storing computer-executable instructions, when executed by one or more of the processors, sends an alert when the fully worn condition is estimated to be less than a certain time period.

64. The system of claim 63 wherein the time period is the time between capturing the image and the next scheduled downtime for the earth working equipment.

65. The system of claim 63 wherein the time period is a certain number of days following capturing the image.

66. The system of claim 62 wherein the memory storing computer-executable instructions, when executed by one or more of the processors, sends an alert when the extent of wear is within a certain percentage of the fully worn condition.

67. The system of claim 61 including a calibration device near the ground engaging tool such that the calibration device is included in the captured image of the ground engaging tool, and wherein the memory storing computer-executable instructions, when executed by one or more of the processors, uses the calibration device in the captured image to determine a scale of the captured image and determine the extent of the wear and/or the estimated fully worn condition.

68. The system of claim 60 wherein the memory storing computer-executable instructions, when executed by one or more of the processors, shows edge markers on the display with the captured image, enables adjusting of the edge markers to align them on opposite edges of the ground engaging tool in the captured image, and uses the distance between the edge markers to calculate the extent of the wear and/or the estimated fully worn condition.

69. The system of claim 60 including measuring device to measure a dimension of the ground engaging tool for use by the memory storing computer-executable instructions to calculate the extent of the wear and/or the estimated fully worn condition.

70. The system of claim 60 wherein the communication interface receives information regarding the ground engaging tool from at least one sensor in the ground engaging tool, and shows the information on the display.

71. The system of claim 70 wherein the received information includes the kind of ground engaging tool and/or its position on the earth working equipment.

72. The system of claim 60 wherein the memory storing computer-executable instructions, when executed by one or more of the processors, estimates the fully worn condition based on wear information obtained at multiple points in time.

73. The system of claim 60 wherein the memory storing computer-executable instructions, when executed by one or more of the processors, estimates the fully worn condition based on information pertaining the ground conditions where the ground engaging tool is being used.

74. The system of claim 60 wherein the memory storing computer-executable instructions, when executed by one or more of the processors schedules when to replace the ground engaging tool secured to the earth working equipment based on the extent of the wear and/or the estimate of the fully worn condition.
